(19) United States
(12) Patent Application Publication
(10) Pub. No.: US 2009/0126649 A1
(43) Pub. Date: May 21, 2009

(54) Pet Grooming Tool with Vacuum or Blower Attachment and Method of Using the Same

(75) Inventors: David R. Porter, Sunset Hills, MO (US); Angela L. Porter, Sunset Hills, MO (US)

Correspondence Address: THOMPSON COBURN LLP, ONE US BANK PLAZA, SUITE 3500, ST LOUIS, MO, 63101, US

(73) Assignee: FURMINATOR, INC., Fenton, MO (US)

(21) Appl. No.: 11/942,437

(22) Filed: Nov. 19, 2007

(51) Int. Cl. A01K 13/00; A47L 5/14

(52) U.S. Cl. 119/601; 119/625; 15/246.2

(57) ABSTRACT

A pet grooming tool comprises a toothed portion, an air passage portion, and a handle portion. The toothed portion comprises a plurality of teeth arranged in a row. The air passage portion comprises a first opening, a second opening, and a fluid passageway. The first opening is positioned adjacent the toothed portion. The second opening is adapted and configured to couple to an air hose. The fluid passageway extends from and operatively connects the first opening to the second opening. The handle portion is connected to the toothed portion and comprises a grip portion. The grip portion is configured and adapted to be grasped by a hand of a person.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to pet grooming tools and, more particularly, to toothed pet grooming tools of the type used to remove loose fur (i.e., fur that is not attached to the skin) from the coat of a pet.

2. Related Art

Various types of pet grooming tools have been developed for the specific purpose of removing loose fur from the coats of pets. One of the most successful types of such grooming tools is described in U.S. Pat. Nos. 7,222,588, 7,077,076, and 6,782,846 and comprises a plurality of teeth arranged in a row. While such tools effectively remove loose fur from pets, the removed fur may become airborne and must be collected after grooming a pet. This may be bothersome to people that are allergic to the fur of the pet.

### SUMMARY OF THE INVENTION

The methods and pet grooming tools of the present invention improve the usability of pet grooming tools adapted to remove loose fur by providing a pet grooming tool with a air passage portion having an opening adjacent the row of the teeth of the toothed portion. The air passage portion also comprises another opening that is configured to be attached to a vacuum hose. As such, a vacuum can be generated adjacent the toothed portion of the teeth while the pet grooming tool is being used to remove loose fur from a pet. The vacuum draws loose fur through the air passage portion of the grooming tool and into the vacuum system, thereby eliminating or greatly reducing the amount of fur that becomes airborne or that is required to be collected after the grooming process. Preferably, the air passage portion is adapted and configured to be removable from the remainder of the pet grooming tool. Additionally, the air passage portion of the pet grooming tool can alternatively be connected to a blower hose in a manner forcing air out of the air passage portion adjacent the toothed portion of the pet grooming tool. This is useful in blow drying the fur of a pet.

In one aspect of the invention, a pet grooming tool comprises a toothed portion, an air passage portion, and a handle portion. The toothed portion comprises a plurality of teeth arranged in a row and a plurality of edge segments. A gap exists between each adjacent pair of the teeth. The edge segments are adapted to engage loose fur in a pet's coat as such loose fur extends through the gaps in a manner removing the loose fur from the pet's coat. The air passage portion comprises a first opening, a second opening, and a fluid passageway. The first opening is positioned adjacent the toothed portion. The second opening is adapted and configured to couple to an air hose. The fluid passageway extends from and operatively connects the first opening to the second opening. The handle portion is connected to the toothed portion and comprises a grip portion. The grip portion is configured and adapted to be grasped by a hand of a person. The fluid passageway is exterior to the grip portion.

In another aspect of the invention, a pet grooming tool comprising a toothed portion, a handle portion, and an air passage portion. The toothed portion comprises a plurality of teeth arranged in a row and a plurality of edge segments. A gap exists between each adjacent pair of the teeth. The edge segments are adapted to engage loose fur in a pet's coat as such loose fur extends through the gaps in a manner removing the loose fur from the pet's coat. The handle portion is connected to the toothed portion and comprises a grip portion. The grip portion is configured and adapted to be grasped by a hand of a person. The air passage portion comprises a first opening, a second opening, and a fluid passageway. The first opening is positioned adjacent the toothed portion. The second opening is adapted and configured to couple to an air hose. The fluid passageway extends from and operatively connects the first opening to the second opening. The air passage portion is positioned between the handle portion and the toothed portion.

In yet another aspect of the invention, a method comprises a step of providing a pet grooming tool. The pet grooming tool comprises a toothed portion, a handle portion, and at least one threaded fastener. The toothed portion comprises a plurality of teeth arranged in a row and a plurality of edge segments. A gap exists between each adjacent pair of the teeth. The edge segments are adapted to engage loose fur in a pet's coat as such loose fur extends through the gaps in a manner removing the loose fur from the pet's coat. The handle portion is connected to the toothed portion via the threaded fastener and comprises a grip portion. The grip portion is configured and adapted to be grasped by a hand of a person. The method further comprises a step of disconnecting the handle portion from the toothed portion by unscrewing the threaded fastener. Still further, the method comprises a step of providing an air passage portion. The air passage portion comprises a first opening, a second opening, and a fluid passageway. The second opening is adapted and configured to couple to an air hose. The fluid passageway extends from and operatively connects the first opening to the second opening. Furthermore, the method comprises a step of securing the handle portion to the toothed portion with the air passage portion between the handle portion and the toothed portion via a threaded fastener in a manner such that the first opening is positioned adjacent the toothed portion.

Further features and advantages of the present invention, as well as the operation of various embodiments of the present invention, are described in detail below with reference to the accompanying drawings.

### BRIEF DESCRIPTION OF THE DRAWINGS

FIG. 1 illustrates a perspective view of a pet grooming tool in accordance with the invention.

FIG. 2 illustrates another perspective view of the tool shown in FIG. 1.

FIG. 3 illustrates a perspective exploded assembly view of tool shown FIGS. 1 and 2.

FIG. 4 illustrates another perspective exploded assembly view of tool shown FIGS. 1 and 2.

FIG. 5 illustrates a front elevation view of the toothed portion of the tool shown in FIGS. 1-4.

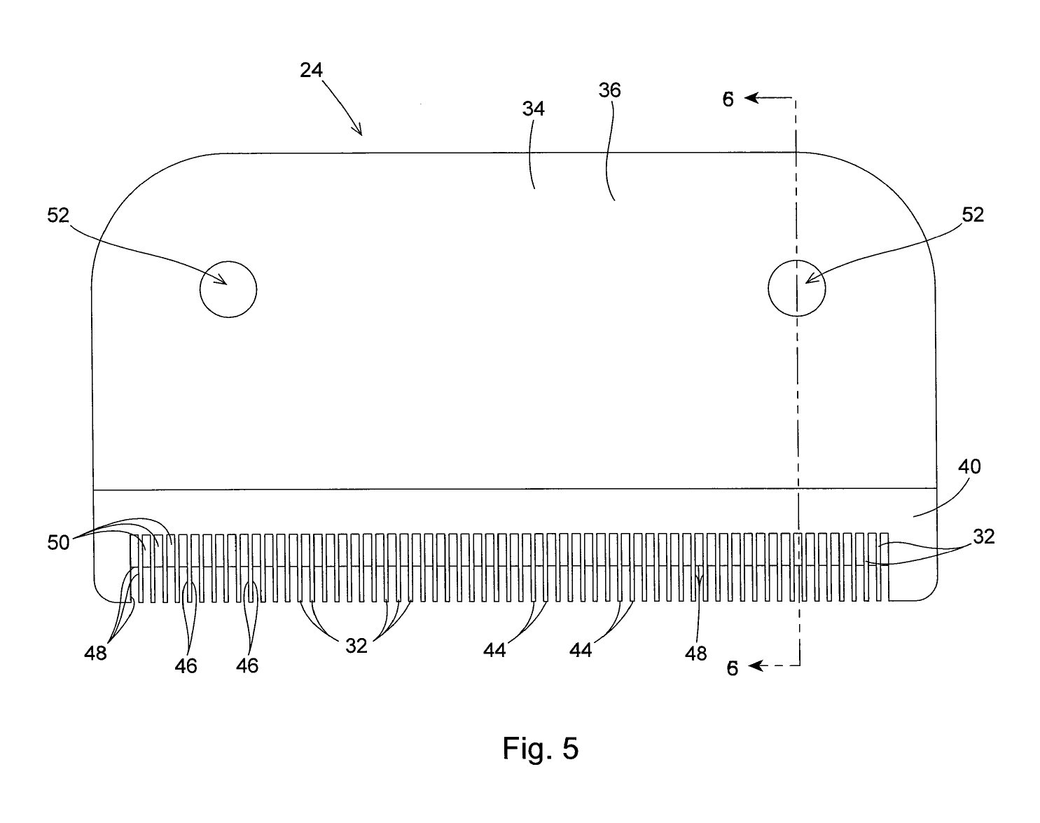

FIG. 6 illustrates a cross-sectional view of the toothed portion of the tool shown in FIGS. 1-4, taken about the line 6-6 shown in FIG. 5.

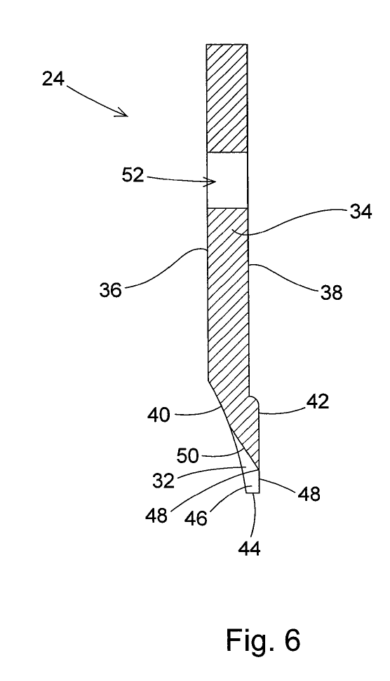

FIG. 7 illustrates a front elevation view of the air passage portion of the tool shown in FIGS. 1-4.

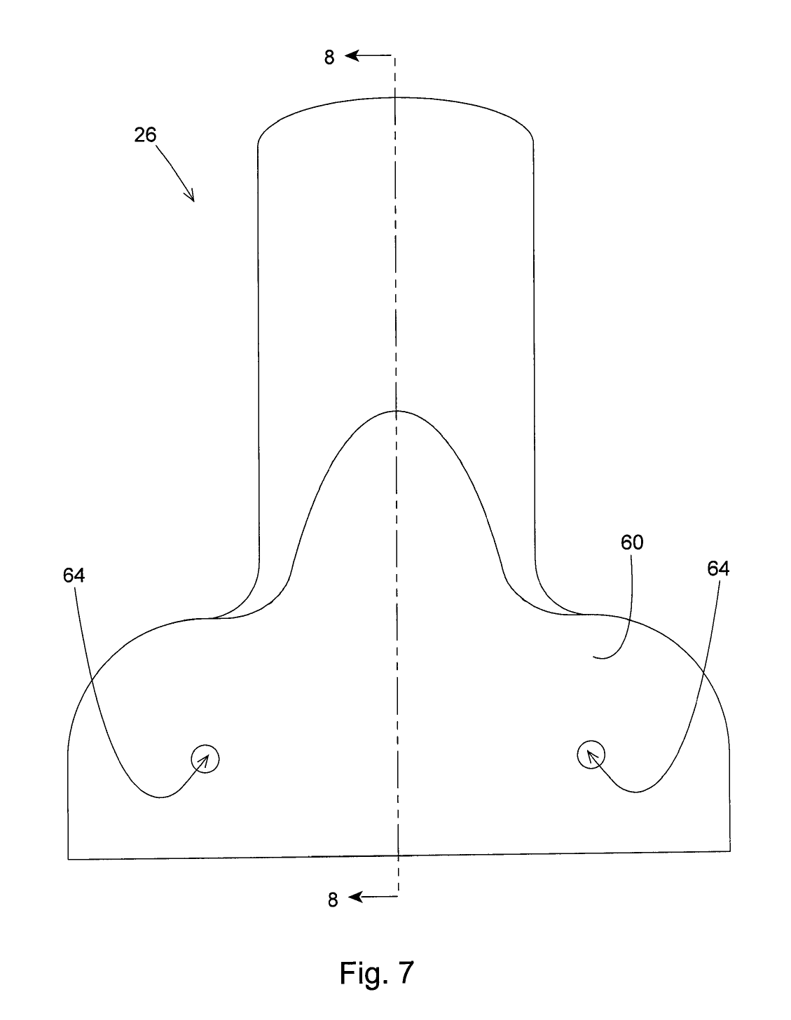

FIG. 8 illustrates a cross-sectional view of the air passage portion of the tool shown in FIGS. 1-4, taken about the line 8-8 shown in FIG. 7.

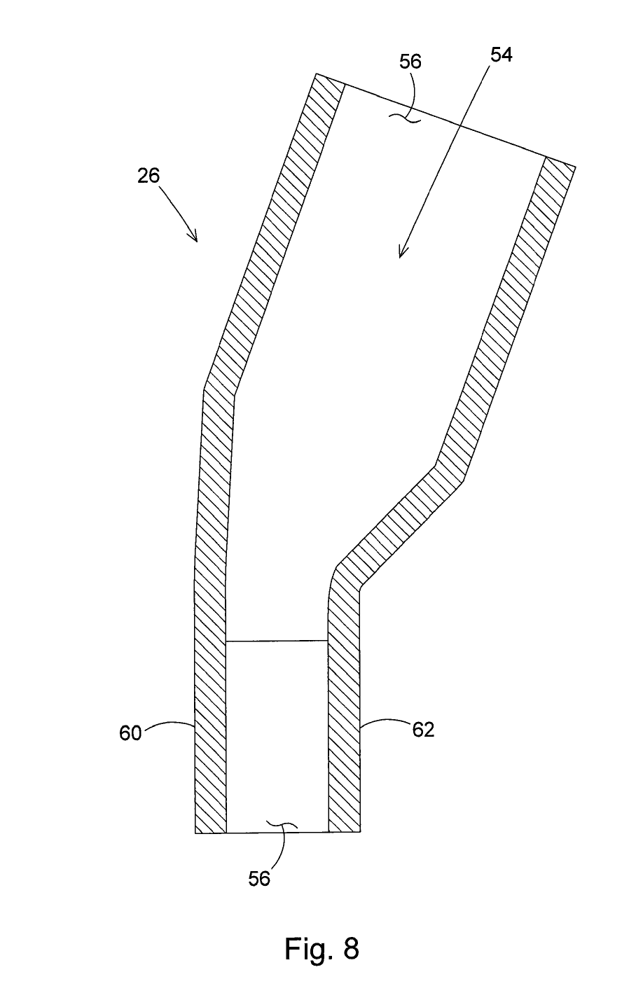

FIG. 9 illustrates a perspective exploded assembly view of the pet grooming tool shown in FIGS. 1-4, with the air passage portion removed therefrom.

Reference numerals in the written specification and in the drawing figures indicate corresponding items.

### DETAILED DESCRIPTION OF THE PREFERRED EMBODIMENTS

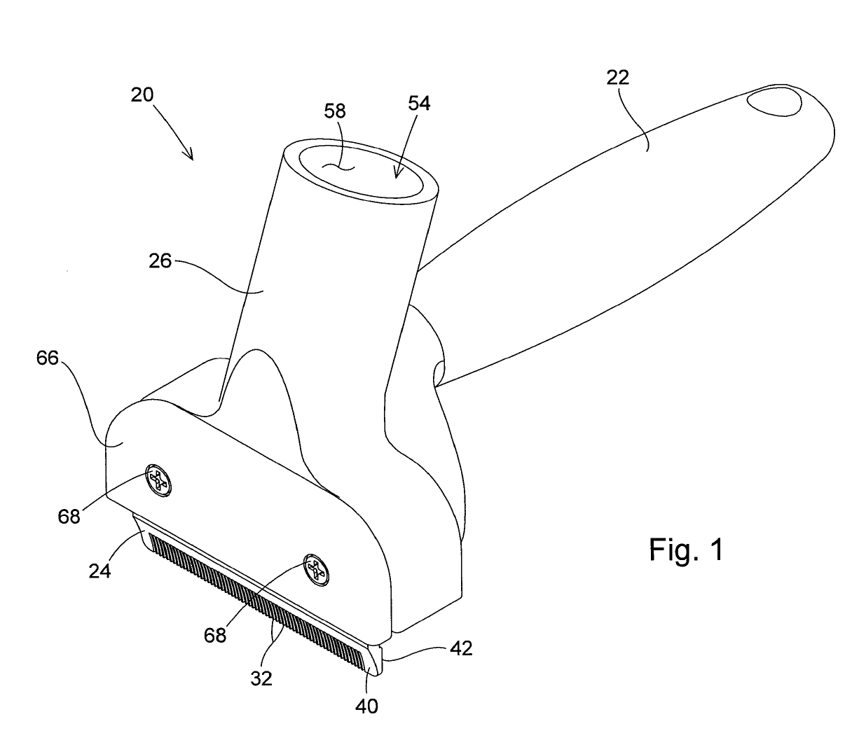

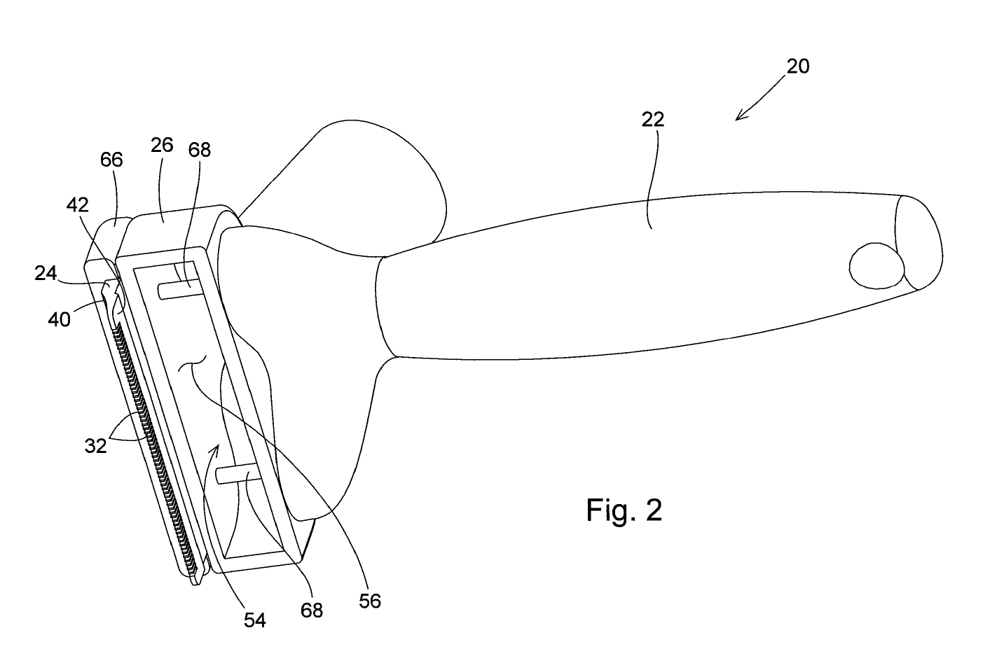

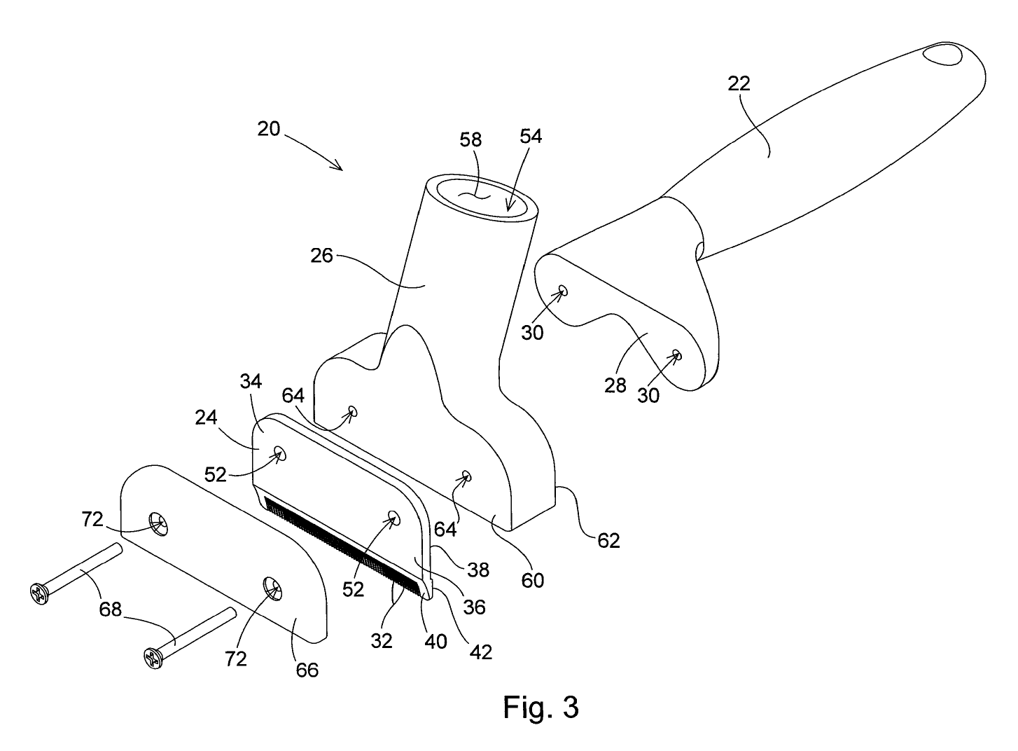

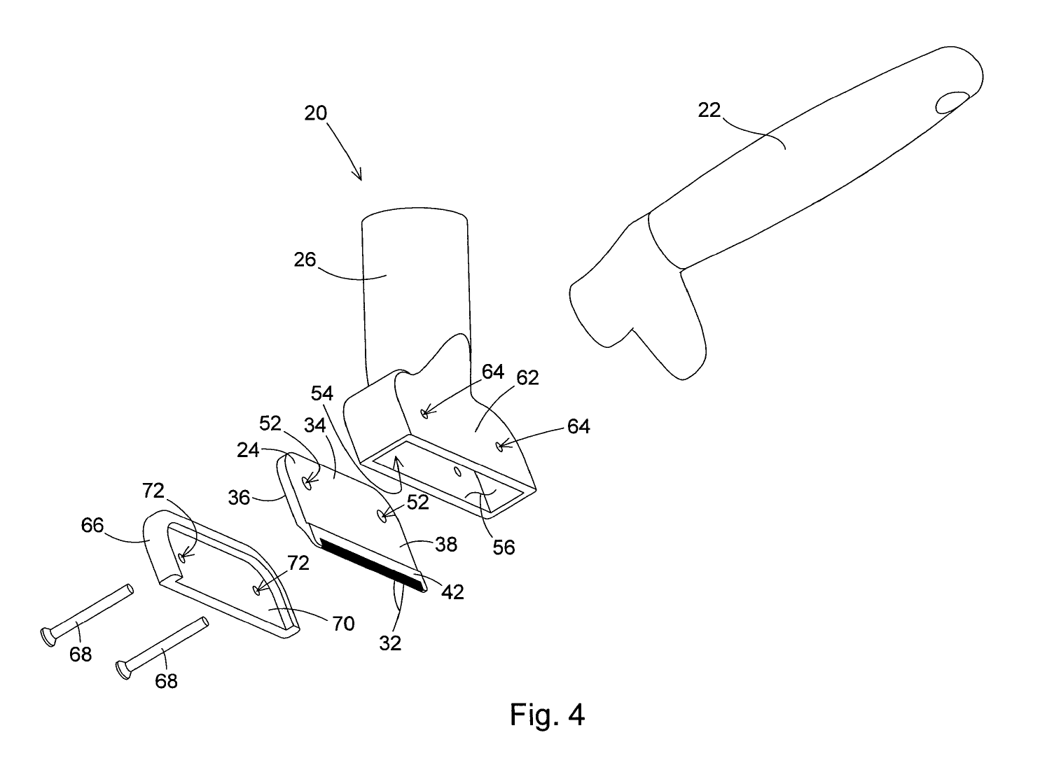

An embodiment of a pet grooming tool comprising an air passage portion in accordance with the invention is shown in FIGS. 1-4. The pet grooming tool 20 comprises a handle portion 22, a toothed portion 24, and an air passage portion 26. Preferably, but not necessarily, the handle portion 22, toothed portion 24, and air passage portion 26 are formed as individual parts that are separable from each other.

The handle portion 22 is configured to be held in one hand and preferably is elongate about a longitudinal axis. Preferably the handle portion 22 is formed primarily of a relatively rigid plastic and has a softer rubbery grip portion. The handle portion 22 also preferably comprises a bearing surface 28 at one of its longitudinal ends. Two threaded holes 30 extend into the handle portion from the bearing surface 28. Preferably the threaded holes 30 are formed by threaded metal inserts that are molded over during the formation of the handle portion 22.

The toothed portion 24 of the pet grooming tool 20 is preferably formed of metal and comprises a plurality of teeth 32. The teeth 32 preferably form a straight row. Preferably, the toothed portion 24 comprises a main body 34 having opposite forward facing 36 a rearward facing 38 surfaces. The forward facing 36 and rearward facing 38 surfaces are preferably parallel planar surfaces. The teeth 32 preferably extend from a front surface 40 to a back surface 42. The front surface 40 preferably tapers toward the back surface 42 as said surfaces extend toward the tips 44 of the teeth 32. Preferably the sides 46 of the teeth 32 intersect the back surface 42 in a manner forming a plurality of edge segments 48. The edge segments 48 formed by the sides 46 of the teeth 32 have an angle of approximately ninety degrees. Forward facing surface segments 50 extend between the teeth 32 and intersect the back surface 42 in manner forming additional edge segments 48. The edge segments 48 formed by the forward facing surface segments 50 are preferably significantly acute (≈40 degrees or less). The toothed portion 24 also preferably comprises a pair of through holes 52 that extend through its main body 34.

The air passage portion 26 is preferably formed as a monolithic piece of homogeneous plastic material. The air passage portion 26 comprises a fluid passageway 54 that extends between and operatively connects first 56 and second 58 openings. The first opening 56 preferably has a generally rectangular cross-section and the second opening 58 preferably has a generally circular cross-section. The second opening 58 is preferably configured and adapted to be connected to an air hose, such as a vacuum hose or blower hose. The fluid passageway 54 preferably transitions smoothly from the generally rectangular first opening 56 to the generally circular second opening 58 and preferably tilts slightly towards the rear as it approaches the second opening. The air passage portion 26 also preferably has opposite front 60 and rear 62 surfaces that are planar and parallel to each other. Additionally, the air passage portion 26 also preferably has a pair of through holes 64 that extend from its front surface 60 to its rear surface 62.

The pet grooming tool 20 described above also preferably comprises a trim cap 66 and two screws 68. The trim cap 66 is preferably a piece of plastic having a recess 70 that is dimensioned to receive the main body 34 of the toothed portion 24 of the pet grooming tool 20. The trim cap 66 also has two countersunk through holes 72.

The pet grooming tool 20 is assembled by placing the rear surface 62 of the air passage portion 26 against the bearing surface 28 of the handle portion 22, with the through holes 64 of the air passage portion aligned with the threaded holes 30 of the handle portion. The rearward facing surface 38 of the toothed portion 24 of the pet grooming tool 20 is placed against the front surface 60 of the air passage portion 26 with its through holes 52 also aligned with the threaded holes 30 of the handle portion 22. Additionally, the trim cap 74 is placed against the toothed portion 24 with the main body 34 of the tooth portion positioned in the recess 70 of the trim cap and the countersunk holes 72 of the trim cap aligned with the threaded holes 30 of the handle portion 22. The screws 68 are then aligned with the threaded holes 30 of the handle portion 22 and are threaded thereinto, thereby clamping the components of the pet grooming tool 20 to one another. As assembled, the trim cap 74 conceals the main body 34 of the toothed portion 24 thereby improving the aesthetics of the pet grooming tool 20.

In use, the toothed portion 24 of the pet grooming tool 20 is preferably pulled through the coat of a furry pet by grasping the handle portion 22. As the toothed portion 24 is pulled through the pet's coat, the front surface 40 of the toothed portion trails the back surface 42. During this process, the edge segments 48 of toothed portion 24 of the pet grooming tool 20 grab loose fur within the pet's coat and force said loose fur from the coat. This effectively removes the loose fur from the pet's coat. The majority of such loose fur clumps up against the back surface 42 of the toothed portion 24 of the grooming tool 20 as the teeth 32 move through the pets coat. Absent any air passing through the fluid passageway 54 of the air passage portion 26, such fur would typically fall to the floor when the grooming tool 20 is disengaged from the pet's coat. However, by applying a vacuum to the second opening 58 of the air passage portion 26 of the grooming tool 20 via a standard vacuum hose, air is drawn into the first opening 56 of the air passage portion. The flow of air into the air passage portion 26 through the first opening 56 also draws nearby loose fur to be drawn through the air passage portion and ultimately into the vacuum hose. The shaped of the first opening 56 of the air passage portion 26 and its proximity to the back surface 42 of the toothed portion 24 aids in the ability of the air passage portion to draw in loose hair.

Rather than a vacuum, pressurized air can applied to the second opening 58 of the air passage portion 26 via a blower hose. When this is done, air is forced through the fluid passageway 54 of the air passage portion 26 and exits through the first opening 56. This blown air allows the grooming tool 20 to function as a fur dryer as it is used to groom a pet.

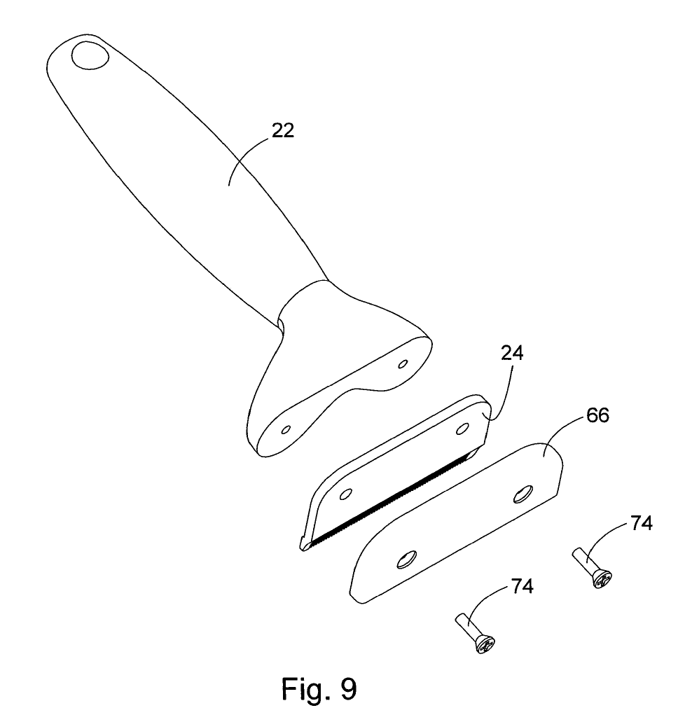

The air passage portion 26 of the pet grooming tool 20 described above is configured and adapted to be removed from the pet grooming tool. This is done by removing the screws 68 from the pet grooming tool 20 and then removing the air passage portion 26 from the other components of the grooming tool. The rearward facing surface 38 of the toothed portion 24 of the pet grooming tool 20 can then be placed directly against the bearing surface 28 of the handle portion 22 (as depicted in FIG. 9). A second set of screws 74, which are shorter than the screws described above, can then be used to secure the remaining components together. Similarly, this process can be reversed to add the air passage portion 26 to a similar pet grooming tool that lacks such an air passage portion.

In view of the foregoing, it will be seen that the several advantages of the invention are achieved and attained.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

What is claimed is:

1. A pet grooming tool comprising:
a toothed portion, the toothed portion comprising a plurality of teeth arranged in a row and a plurality of edge segments, there being a gap between each adjacent pair of the teeth, the edge segments being adapted to engage loose fur in a pet's coat as such loose fur extends through the gaps in a manner removing the loose fur from the pet's coat;
an air passage portion, the air passage portion comprising a first opening, a second opening, and a fluid passageway, the first opening being positioned adjacent the toothed portion, the second opening being adapted and configured to couple to an air hose, the fluid passageway extending from and operatively connecting the first opening to the second opening; and
a handle portion, the handle portion being connected to the toothed portion and comprising a grip portion, the grip portion being configured and adapted to be grasped by a hand of a person, the fluid passageway being exterior to the grip portion.

2. A pet grooming tool in accordance with claim 1 wherein the air passage portion is removably attached to the toothed portion and the handle portion.

3. A pet grooming tool in accordance with claim 2 wherein the toothed portion, the air passage portion, and the handle portion are held together via at least one threaded fastener.

4. A pet grooming tool in accordance with claim 1 wherein the first opening of the air passage portion is generally rectangular in shape and has its longest dimension oriented generally parallel to the row of the teeth.

5. A pet grooming tool in accordance with claim 1 wherein the second opening of the air passage portion is generally circular in shape and faces in a direction generally opposite to the first opening.

6. A pet grooming tool in accordance with claim 5 wherein the first opening of the air passage portion is generally rectangular in shape and has its longest dimension oriented generally parallel to the row of the teeth.

7. A pet grooming tool in accordance with claim 6 wherein the air passage portion is removably attached to the toothed portion and the handle portion via at least one threaded fastener.

8. A pet grooming tool comprising:
a toothed portion, the toothed portion comprising a plurality of teeth arranged in a row and a plurality of edge segments, there being a gap between each adjacent pair of the teeth, the edge segments being adapted to engage loose fur in a pet's coat as such loose fur extends through the gaps in a manner removing the loose fur from the pet's coat;
a handle portion, the handle portion being connected to the toothed portion and comprising a grip portion, the grip portion being configured and adapted to be grasped by a hand of a person;
an air passage portion, the air passage portion comprising a first opening, a second opening, and a fluid passageway, the first opening being positioned adjacent the toothed portion, the second opening being adapted and configured to couple to an air hose, the fluid passageway extending from and operatively connecting the first opening to the second opening, the air passage portion being positioned between the handle portion and the toothed portion.

9. A pet grooming tool in accordance with claim 8 wherein the air passage portion is removably attached to the toothed portion and the handle portion.

10. A pet grooming tool in accordance with claim 9 wherein the toothed portion, the air passage portion, and the handle portion are held together via at least one threaded fastener.

11. A pet grooming tool in accordance with claim 8 wherein the first opening of the air passage portion is generally rectangular in shape and has its longest dimension oriented generally parallel to the row of the teeth.

12. A pet grooming tool in accordance with claim 8 wherein the second opening of the air passage portion is generally circular in shape and faces in a direction generally opposite to the first opening.

13. A method comprising:
providing a pet grooming tool, the pet grooming tool comprising a toothed portion, a handle portion, and at least one threaded fastener, the toothed portion comprising a plurality of teeth arranged in a row and a plurality of edge segments, there being a gap between each adjacent pair of the teeth, the edge segments being adapted to engage loose fur in a pet's coat as such loose fur extends through the gaps in a manner removing the loose fur from the pet's coat, the handle portion being connected to the toothed portion via the at least one threaded fastener and comprising a grip portion, the grip portion being configured and adapted to be grasped by a hand of a person;
disconnecting the handle portion from the toothed portion by unscrewing the at least one threaded fastener;
providing an air passage portion, the air passage portion comprising a first opening, a second opening, and a fluid passageway, the second opening being adapted and configured to couple to an air hose, the fluid passageway extending from and operatively connecting the first opening to the second opening;
securing the handle portion to the toothed portion with the air passage portion between the handle portion and the toothed portion via at least one threaded fastener in a manner such that the first opening is positioned adjacent the toothed portion.

14. A method in accordance with claim 13 further comprising a step of applying a partial vacuum to the second opening of the air passage portion via coupling a hose to the second opening.

15. A method in accordance with claim 14 further comprising moving the pet grooming tool relative to a pet's coat in a manner such that the edge segments of the toothed portion engage loose fur in the pet's coat and remove such loose fur from the pet's coat, and wherein such loose fur is drawn through the fluid passageway of the air passage portion as a result of the partial vacuum.

16. A method in accordance with claim 13 further comprising applying pressurized air to the second opening of the air passage portion via coupling a hose to the second opening.

17. A method in accordance with claim 16 further comprising moving the pet grooming tool relative to a pet's coat in a manner such that the edge segments of the toothed portion engage loose fur in the pet's coat and remove such loose fur from the pet's coat

18. A method in accordance with claim 16 further comprising heating the pressurized air.
